(19) United States
(12) Patent Application Publication
(10) Pub. No.: US 2007/0176934 A1
(43) Pub. Date: Aug. 2, 2007

(54) Method, program, and apparatus enabling font color selection enhancement

(75) Inventor: Mika T. Toivola, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/343,716

(22) Filed: Jan. 30, 2006

(51) Int. Cl. G06T 11/00

(52) U.S. Cl. 345/467

(57) ABSTRACT

In one aspect thereof, this invention provides a method for displaying the font colors of a selected portion of text having a plurality of font colors. The method includes gathering data about the selected portion of text including at least font color attributes used in the selected portion of text; determining, using the gathered data, at least a plurality of font colors used in the selected portion of text; and, using the determined information, displaying the plurality of font colors of the selected portion of text in at least one font color display component, wherein at least two of the colors of the plurality of font colors comprise a display portion of at least one font color display component.

### TECHNICAL FIELD

The teachings in accordance with the exemplary embodiments of this invention relate generally to text attributes and formatting and, more specifically, relate to text attributes and formatting with regards to word-processing and other types of software that display alphanumeric characters to a user.

### BACKGROUND OF THE INVENTION

Color has been a significant aspect of computer displays since IBM introduced the Color Graphics Adapter (CGA) standard in 1981, allowing IBM PCs to display more than two colors. Computer displays use the RGB color model, an additive model in which red, green, and blue light are combined in various ways to generate other colors. Color depth, in units of bits per pixel (bpp), describes the number of bits used to represent the color of a single pixel in a bitmapped image or video frame buffer. An easy way to determine the number of available colors from a bpp value is: colors available=2ˆ (bpp). For example, 1-bit color (1 bpp) has 2 colors available (monochrome), 2-bit color has 4 colors available (CGA), and 4-bit color has 16 colors available. As the number of bits increases, the number of colors available also increases. This has a practical limit based on human perception since human eyes, on average, can distinguish up to around ten million colors (depending on various factors such as age and eyesight). Hence, 24-bit color, known as Truecolor, is most often the highest available color setting for computers as it can display up to 16,777,216 mixed colors. Another well-known color setting is Highcolour. Highcolour refers to 15 or 16-bit color in which 5 bits represent red (2ˆ5=32 levels or shades), 5 bits represent blue (32 levels), and 5 or 6 bits represent green (32 or 64 levels, respectively). 15-bit Highcolour allows for 32,768 mixed colors (32×32×32=32,768) while 16-bit Highcolour allows for 65,536 mixed colors (32×32×64=65,536). In contrast, Truecolor (24-bit) uses 8 bits to represent each color, leading to 256 (2ˆ8) levels of each color for a total number of 16,777,216 (256×256×256=16,777,216) mixed colors available.

Conventional computer codes often represent colors based on the Truecolor palette and theory. That is, the codes are designed to display colors either as a function of or using identifiers based on 256 levels of each of the three basic RGB colors, red, green, and blue. To that end, decimal representations of Truecolor are often written (R,G,B), where R stands for the level of red (ranging from 0 to 255), G stands for the level of green (ranging from 0 to 255), and B stands for the level of blue (ranging from 0 to 255). In such notation, the color blue is represented as (0,0,255) and the color black, being the absence of color, is represented as (0,0,0). Most computer codes use a hex triplet number to represent colors. A hex triplet number is a six-digit, three-byte hexadecimal number not too dissimilar from the (R,G,B) decimal Truecolor notation. To obtain a hex triplet number from a (R,G,B) decimal Truecolor notation, one simply converts the R, G, and B values from the 0-to-255 decimal scale into 00-FF hexadecimal and concatenates the results in the same order (red green blue). For example, the color blue, represented in decimal Truecolor as (0,0,255), is written in hex triplet as #0000FF (0 red yields hex 00, 0 green yields hex 00, and 255 blue yields hex FF). Since hexadecimal is a base-16 numeral system, a two-digit hexadecimal number can represent up to 256 different values. Hence, hexadecimal notation meshes well with 24-bit color since the latter has 256 levels for each of the three basic RGB colors. Many conventional computer codes or languages use hex triplet numbers for representing colors, including HTML (hypertext markup language) and CSS (cascading style sheets language).

Monitors able to display only 256 colors will not be able to display all 16,777,216 mixed colors of Truecolor accurately. This lead to the establishment of “web-safe” colors, a set of colors considered safe to use since they are displayed accurately in 8-bit color. The web-safe color scheme has 6 shades of each color, red, green, and blue, leading to 216 available colors (6×6×6=216). The 6 web-safe shades are represented in decimal as 0, 51, 102, 153, 204, and 255, and in hexadecimal as 00, 33, 66, 99, CC, and FF. The six values represent six desired intensities: 0%, 20%, 40%, 60%, 80%, and 100%. Many online charts are available depicting the web-safe colors and their corresponding hex triplet number. (See, e.g., Photius Coutsoukis, “Complete HTML True Color Chart,” 2005, available at http://www.immigration-usa.com/html_colors.html) Although modern computer equipment is usually capable of displaying 24-bit color, the web-safe color scheme remains a commonly-used palette, especially among web site designers.

Current word-processing software allow the user to customize the document created. One available option is to change the font color of various portions of text. Users may utilize this text attribute to distinguish letters, words, phrases, sentences, or portions of the document.

Changing font colors is typically performed either through a toolbar button, a pull-down menu, or a separate font attribute dialogue. Although the appearance of this toolbar button, pull-down menu, and font attribute dialogue may differ depending on the software, the underlying elements and functionality remain the same. Most current software display the color of the selected text by means of a colored font color display component where the color of the font color display component is the color of the text. Some software also include a default option, most often the color black, sometimes labeled “Automatic.”

Problems may arise when the user attempts to work with more than one font color. In the toolbar button, pull-down menu, and dialogue, current word-processing software is unable to accurately depict selections of text containing more than one font color. In some software the dialogue shows no color while in other software it inaccurately depicts the color, often resorting to the default color.

Further problems arise if a user is attempting to ascertain what font colors are being used in a multicolored block of text. In most current word-processing software, when the text is highlighted, the font color and background color are inverted. For example, when highlighted, black text on a white background is shown as white text on a black background in order to distinguish it from the other text. Any highlighted colored text is similarly inverted. Thus, a user cannot accurately see, in the main window of the document, the colors of highlighted text.

### SUMMARY

The foregoing and other problems are overcome, and other advantages are realized, in accordance with the non-limiting and exemplary embodiments of this invention.

In an exemplary embodiment of the invention, there is provided a method for displaying font colors of a selected portion of text having a plurality of font colors. The method includes gathering data about the selected portion of text including at least font color attributes used in the selected portion of text; determining information, using the gathered data, including at least a plurality of font colors used in the selected portion of text; and displaying, using the determined information, the plurality of font colors of the selected portion of text in at least one font color display component wherein at least two of the colors of the plurality of font colors comprise a display portion of at least one font color display component.

In another exemplary embodiment of the invention, there is provided a computer program for displaying font colors of a selected portion of text having a plurality of font colors where the program instructions are embodied on a tangible computer-readable medium. The computer program implements operations that comprise, in response to a user selecting a portion of displayed text, gathering data about the selected portion of text including at least font color attributes used in the selected portion of text; determining information, using the gathered data, including at least a plurality of font colors used in the selected portion of text; and displaying, using the determined information, the plurality of font colors of the selected portion of text in at least one font color display component wherein at least two of the colors of the plurality of font colors comprise a display portion of at least one font color display component.

In a further exemplary embodiment of the invention, there is provided an apparatus that includes means for gathering data about a selected portion of text including at least font color attributes used in the selected portion of text; means for determining information, using the gathered data, including at least a plurality of font colors used in the selected portion of text; and means for displaying, using the determined information, the plurality of font colors of the selected portion of text in at least one font color display component wherein at least two of the colors of the plurality of font colors comprise a display portion of at least one font color display component.

In a still further exemplary embodiment of the invention, there is provided an apparatus for displaying font colors of a selected portion of text having a plurality of font colors, the apparatus having a display, a user interface, a memory, and at least one data processor coupled to the memory. The at least one data processor is configured to execute a program of machine-readable instructions, capable of interacting with the user interface and display, operable to gather data about a selected portion of text including at least the font color attributes used in the selected portion of text; determine information, using the gathered data, including at least a plurality of font colors used in the selected portion of text; and display, using the determined information, the plurality of font colors of the selected portion of text in at least one font color display component wherein at least two of the colors of the plurality of font colors comprise a display portion of at least one font color display component.

In another exemplary embodiment of the invention, there is provided a computer program for displaying font colors of a selected portion of text having a plurality of font colors where the program instructions are embodied on a tangible computer-readable medium. The computer program implements operations that comprise, in response to a user selecting a portion of displayed text, gathering data about the selected portion of text including at least font color attributes used in the selected portion of text; determining information, using the gathered data, including at least a plurality of font colors used in the selected portion of text; and displaying, using the determined information, the plurality of font colors of the selected portion of text in at least two font color display components, wherein each color of the plurality of font colors comprises a separate font color display component.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1A is a simplified block diagram of various electronic devices that are suitable for use in practicing the exemplary embodiments of this invention.

FIG. 1B is a simplified block diagram of various mobile electronic devices that are suitable for use in practicing the exemplary embodiments of this invention;

FIG. 2 depicts a flowchart illustrating the method for practicing the exemplary embodiments of this invention;

FIG. 3 shows a font attribute dialogue in which the font color display component displays all three colors of the given multicolored selected portion of text;

FIG. 4A illustrates a font attribute dialogue in which the font color display component shows the three colors of the given multicolored selected portion of text in proportion to the colors' relative usage;

FIG. 4B is a close up of the font color display component in FIG. 4A, showing the three colors of the given multicolored selected portion of text in proportion to the colors' relative usage;

FIG. 5 depicts a font attribute dialogue in which a separate font color display component is selected for each color of the given multicolored selected portion of text;

FIG. 6A shows a font attribute dialogue in which the font color display component displays all three colors of the given multicolored selected portion of text;

FIG. 6B illustrates an embodiment of the invention in which the user can selectively apply one of the font colors in the font color display component to the entire portion of selected text;

FIG. 6C depicts the result of carrying out the embodiment of FIG. 6B, that is the result of selectively applying one of the font colors in the font color display component to the entire portion of selected text.

### DETAILED DESCRIPTION

It would be desirable to provide techniques that would allow a user to see, in the toolbar button, pull-down menu, or dialogue, the font colors in a multicolored portion of text. Additional functionality would also be desirable to allow the user to select one of the colors in a multicolored portion of text and either apply it to the entire selection or change the color. The exemplary embodiments of this invention fulfill these needs, as is explained in detail below.

An aspect of the embodiments of this invention is to provide techniques that enable a user to see, via a user interface component such as, but not limited to, a toolbar button, pull-down menu, or dialogue, the font colors in a portion of text having a plurality of font colors. This functionality presents the user with additional information and, as will be discussed below, facilitates implementing new actions to aid the user in processing text.

In an exemplary embodiment of this invention, the font colors of the selected text are displayed in at least one font color display component. A font color display component is considered herein to be a mechanism that provides information concerning the font color or font colors of a portion of text, but does not actually display that portion of text. In this manner, a font color display component is distinct from other aspects of word-processing software such as a print preview, a preview component in a font attribute dialogue, and the main editing body or window.

A font color display component can take any shape including, but not limited to, a rectangle or toolbar button. It can be multicolored or it can display only one specific font color. The font color display component can have, as non-limiting examples, a picture, an image, a symbol, an icon, or text associated with it, provided that these are not the portion of text about which the information is given. A font color display component can be interactive, providing additional functions or capabilities, or it can be passive, simply displaying information. The information it supplies can be positive, indicating one or more colors are present, or negative, indicating that one or more colors are not present.

“Text” is considered herein to be any written symbology that imparts information to a reader. While described below in relation to English-language text using the Latin alphabet, the invention can be applied as well to other languages and symbologies including, but not limited to, Kanji, Chinese, and Hindi. In addition, although described below in relation to alphabetic text, the invention can be employed with only numbers or with alphanumeric text.

The text about which a font color display component provides information is referred to herein for convenience as a “selected portion of text,” “selected text,” or “portion of text.” (Note that “portion” may also be used in the plural “portions.”) Although text in most current word-processing software may be “selected” by highlighting it with the cursor, this is not the definition of “selected” employed herein. Rather, a broader definition of the term “selected” is intended, as in “chosen” or “singled out in preference.”

A font attribute dialogue is considered herein to be any region or window in which the user is provided information concerning the specific attribute(s) of a portion of text. It is noted that toolbars, toolbar buttons, and pull-down menus are not considered herein to be examples of a font attribute dialogue. The information concerning the portion of text supplied by a font attribute dialogue usually, but not necessarily, includes one or more of the following: font, font size, font color, underline style, underline color, strikethrough, superscript, subscript, shadow, outline, small caps, relief style, character spacing, and text effects. As is apparent, the information relates to the physical appearance of the portion of text.

To display the font colors in the font color display component, the method, computer program, and apparatus provided by this invention gathers data about the selected portion of text. At a minimum, this data includes font color attributes used in the selected portion of text. However, additional data may also be desirable, such as the relative usage of each color as compared to the entire portion of selected text, and/or the order of the colors as they appear in the selected text. This additional data facilitates further embodiments of this invention as will be identified and discussed below.

The gathered data is used to determine specific information concerning the selected portion of text. As a minimum, the font colors used in the selected text are identified. If the additional data cited above were collected, additional determinations may be made, such as the relative usage of each color, or the order in which the colors appear in the selected text.

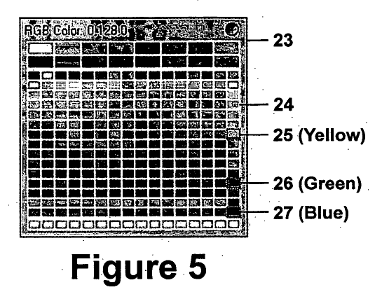

The determinations reached by using the gathered data are employed to display the font colors of the selected portion of text in at least one font color display component. As FIG. 5 clearly illustrates, as discussed in further detail below, the font colors of the portion of text need not be displayed in only one font color display component.

Computer processors generally have limited capacity to perform operations. Because of this limitation, in exemplary embodiments of this invention it may be practical to limit the amount of operations that are performed as a result of this invention. To accomplish this, special trigger functionality may be employed. Trigger functionality enables calculations of the invention to be performed when it is determined that the information used to display color information should be recalculated. This trigger functionality may be a significant feature when there is a font color display visible and the end user is performing text selection operations and/or word processing operations at the same time. One exemplary embodiment of the trigger functionality is implemented by performing calculations of this invention when the end user releases the right button of a mouse-pointing device. For example, in a Microsoft Windows environment, this trigger may be implemented when the Windows message WM_LBUTTONUP is released, thus triggering the performance of calculations of the invention using standard software engineering means. Another exemplary embodiment of the invention is to add trigger functionality responsive to keyboard messages. For example, in Microsoft Windows in a standard PC computer environment, text selection is possible by using left, right, down and up arrows when the shift button is depressed at the same time. In this exemplary embodiment, trigger functionality may be implemented to execute when a key button down message is released if the key that has been pressed has been either a left, right, down or up arrow in conjunction with the shift button being pressed at the same time. If these conditions are met, they trigger the performance of calculations of the invention. In addition to the example implementations described, there are other ways to implement this trigger functionality. The implementation environment of the invention determines how many and what kind of triggers may be implemented. Based on the exemplary embodiments provided, one skilled in the art will appreciate how to implement this trigger functionality with regards to the invention in other environments apart from those of Microsoft Windows and the standard PC.

If the font color display is implemented by using a modal window dialog, where the dialog window blocks user input to all other windows in the program, it may be desirable to perform calculations of the invention when a user decides to open this modal window dialog.

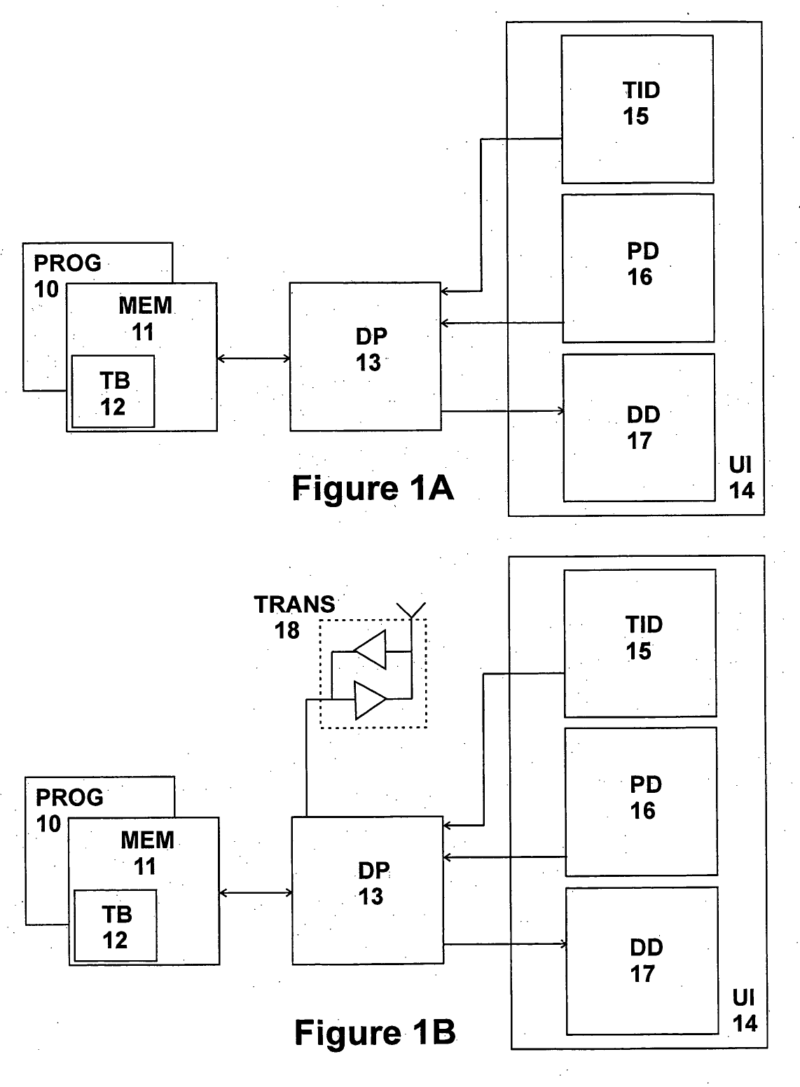

Reference is made first to FIG. 1A for illustrating a simplified block diagram of an electronic device, such as a computer, that is suitable for use in practicing the exemplary embodiments of this invention. In FIG. 1A, the electronic device includes a memory (MEM) 11 that stores program code (PROG) 10, a data processor (DP) 13, and a user interface (UI) 14 comprising a text input device (TID) 15 and a display device (DD) 17. Also shown is an optional pointing device (PD) 16. The TID 15 may be any device for inputting text including, but not limited to, a keyboard or an alphanumeric keypad. The PD 16 may be any device for controlling a pointer displayed on DD 17 including, but not limited to, a mouse or a trackball. The MEM 11 also has a text buffer (TB) 12. The text discussed in subsequent figures is typically inputted using the TID 15 and stored in a TB 12, along with the various attributes of the text, including, but not limited to, the font color of the text. The PROG 10 is assumed to include program instructions that, when executed by the DP 13, enable the electronic device to operate in accordance with the exemplary embodiments of this invention, as will be discussed below in greater detail. Note that the UI 14 allows a user, by interacting with the TID 15 and optional PD 16, to select text, the selected text being displayed on the DD 15.

FIG. 1B illustrates a simplified block diagram of another embodiment showing a mobile electronic device that is suitable for use in practicing the exemplary embodiments of this invention. As in FIG. 1A, the electronic device includes a memory (MEM) 11 that stores program code (PROG) 10, a data processor (DP) 13, and a user interface (UI) 14 comprising a text input device (TID) 15 and a display device (DD) 17. Also shown is an optional pointing device (PD) 16. The TID 15 may be any device for inputting text including, but not limited to, a keyboard or an alphanumeric keypad. The PD 16 may be any device for controlling a pointer displayed on DD 17 including, but not limited to, a mouse or a trackball. The MEM 11 also has a text buffer (TB) 12. The text discussed in subsequent figures is typically inputted using the TID 15 and stored in a TB 12, along with the various attributes of the text, including, but not limited to, the font color of the text. The PROG 10 is assumed to include program instructions that, when executed by the DP 13, enable the electronic device to operate in accordance with the exemplary embodiments of this invention, as will be discussed below in greater detail. Note that the UI 14 allows a user, by interacting with the TID 15 and optional PD 16, to select text, the selected text being displayed on the DD 15. However, in addition to the features of the device pictured in FIG. 1A, the device of FIG. 1B also has a transceiver (TRANS) 18 for wireless communication with other electronic devices. In such a manner, the device of FIG. 1B may be considered to be a mobile electronic device.

In general, the various embodiments of the electronic device pictured in FIG. 1B can include, but are not limited to, cellular telephones, smart phones, personal digital assistants (PDAs), portable computers, image capture devices such as digital cameras, gaming devices, music storage and playback appliances, Internet appliances permitting wireless Internet access and browsing, as well as portable units or terminals that incorporate combinations of such functions.

The embodiments of this invention may be implemented by computer software executable by the DP 13, or by hardware, or by a combination of software and hardware. The MEM 11 may be of any type suitable to the local technical environment and may be implemented using any suitable data storage technology, such as semiconductor-based memory devices, magnetic memory devices and systems, optical memory devices and systems, fixed memory and removable memory. The DP 13 may be of any type suitable to the local technical environment, and may include one or more of general purpose computers, special purpose computers, microprocessors, digital signal processors (DSPs) and processors based on a multi-core processor architecture, as non-limiting examples.

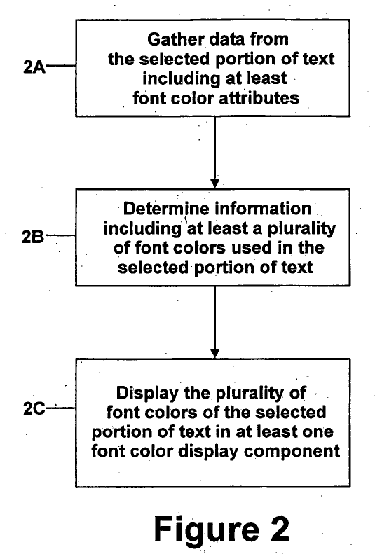

FIG. 2 depicts a flow chart illustrating the method for practicing the exemplary embodiments of this invention. The method is for displaying, in at least one font color display component, the font colors of a selected portion of text having a plurality of font colors. The method comprises the following steps. In box 2A of FIG. 2, the method gathers data about the selected portion of text including at least font color attributes of the selected portion of text.

In box 2B of FIG. 2, the method determines information, using the gathered data, including at least a plurality of font colors used in the selected portion of text. Producing additional information may also be desirable, such as the relative usage of each color as compared to the entire portion of selected text, and/or the order of the colors as they appear in the selected text. In an exemplary embodiment of the invention, determination of the relative usage of colors is implemented by counting total number of characters in the text selected and counting the number of characters of each color that is used in the text selected. This additional information facilitates further embodiments of this invention as will be identified and discussed below.

In box 2C of FIG. 2, the method displays the plurality of font colors of the selected portion of text in at least one font color display component, wherein at least one of the colors of the plurality of font colors comprises a portion of at least one font color display component. As FIG. 5 clearly illustrates, and as discussed in further detail below, the font colors of the portion of text need not be displayed in only one font color display component.

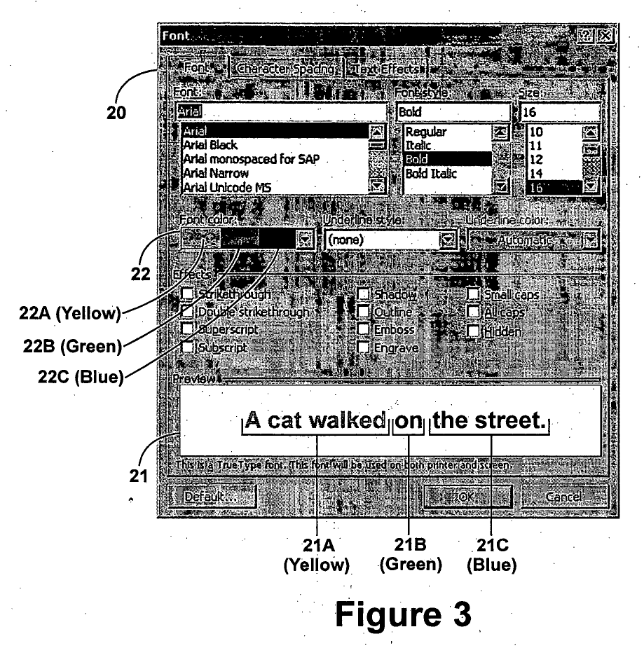

Turning now to FIG. 3, there is shown a font attribute dialogue 20 of a type commonly found in word-processing software. The font attribute dialogue 20 shown is enhanced in accordance with this invention. The attributes given by the font attribute dialogue 20 are for a selected portion of text displayed in a preview component 21. As is apparent, the selected portion of text, “A cat walked on the street.”, is multicolored. The portion “A cat walked” 21A is yellow, with “on” 21B being green, and “the street.” 21C being blue. The font attribute dialogue 20 contains a font color display component 22 that displays the colors of the selected portion of text. Note that the font color display component 22, in accordance with an aspect of this invention, shows all three colors of the selected text. Portion 22A of the font color display component 22 is yellow. Portion 22B is green. Portion 22C is blue.

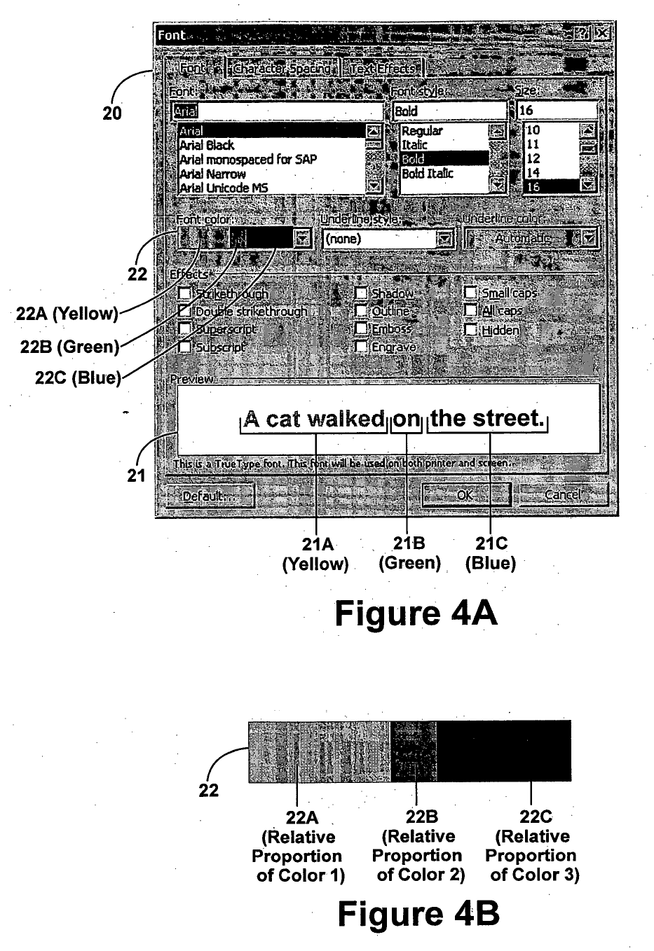

FIG. 4A depicts a font attribute dialogue 20 illustrating another embodiment of the invention. The selected text, shown in preview component 21, is identical to that in FIG. 3. However, font color display component 22 shows the font colors of the selected text with the size of each color shown in proportion to the relative usage of that particular color in the selected text. From this depiction, it is obvious that, in this particular example, the second color 22B is present in the selected portion of text significantly less than the first color 22A or third color 22C, as is made clear in FIG. 4B.

FIG. 4B shows a close up of the font color display component 22 in FIG. 4A. The font color display component 22 displays the relative proportion of the three colors 22A, 22B, 22C as compared to the entire selected portion of text. As noted above, in this particular example, the color represented by portion 22B, here green, is present in the selected text significantly less than the other two colors represented by portions 22A, yellow, and 22C, blue.

Although the font colors in the font color display components 22 of FIGS. 3, 4A, and 4B have appeared in the same order as the colors in the selected portion of text, this ordering is not required by the invention. Similarly, as will be shown in FIG. 5, it is not necessary that a single font color display component be present or contain all of the font colors. In some cases, it may be desirable to employ multiple font color display components to show the font colors of the selected text.

FIG. 5 shows one alternative font attribute dialogue 23 for the same selected portion of text as in previous FIGS. 3, 4A, and 4B. In particular, this font attribute dialogue 23 is specifically directed to displaying the font colors of the selected portion of text and, in accordance with an aspect of this invention, allowing the user to modify a font color or font colors. This font attribute dialogue 23 contains a multitude of font color display components, font color display component 24 being a representative thereof. Of this multitude, three specific font color display components 25, 26, 27 are selected. The three font color display components 25, 26, 27 correspond to the font colors present in the selected portion of text, with each individual font color display component singling out a single color found in the selected portion of text.

As indicated immediately above, the font attribute dialogue 23 of FIG. 5 specifically enables a user not only to view the font colors of the selected text but also, in accordance with an embodiment of this invention, to change a font color or font colors. As a non-limiting example, a user can click-and-hold on font color display component 25 to identify the portion of colored text, here the yellow text in the selected text, whose color the user wishes to change. A user can then drag the selection box formerly selecting font color display component 25 to another font color display component in the font attribute dialogue 23. In so doing, the font color of the portion of text represented by font color display component 25, here the formerly-yellow text in the selected text, can be changed to a different font color.

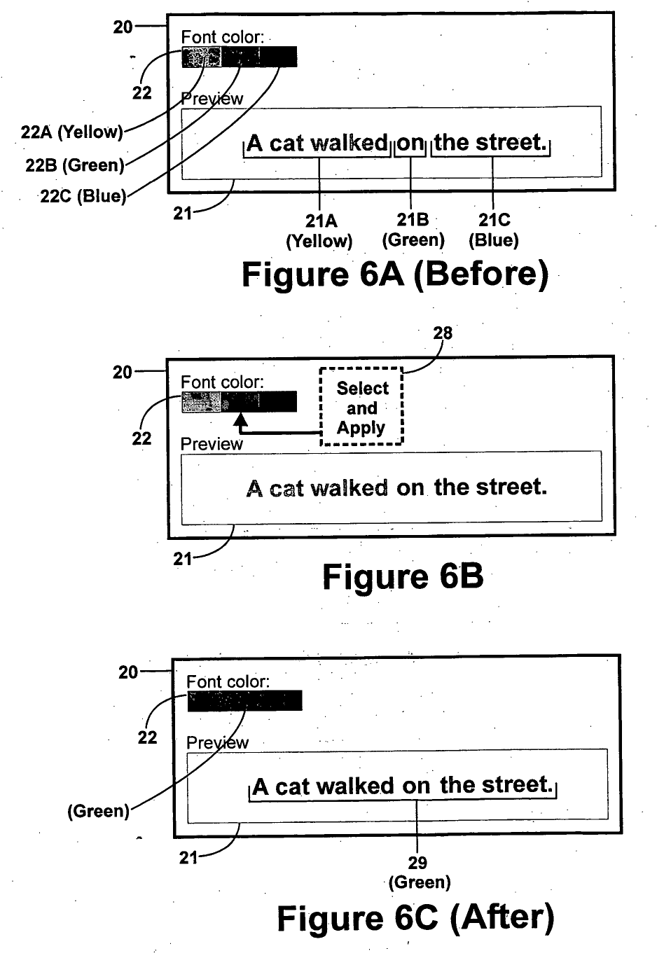

FIGS. 6A, 6B, and 6C illustrate another embodiment of the invention. FIG. 6A shows a font attribute dialogue 20 before any action is taken. FIG. 6B shows the availability to a user of selecting a single color of the font color display component 22 and applying it to the entirety of the selected text. FIG. 6C shows the result after a user has selected a color and applied it to the entirety of the selected text. These figures are described in greater detail immediately below.

FIG. 6A depicts a font attribute dialogue 20 having a font color display component 22 and a preview component 21. The preview component 21 indicates that the selected text, as previously employed in FIGS. 3, 4A, 4B, and 5, is the text “A cat walked on the street.” In this text, as displayed in preview component 21, the words “A cat walked” 21A are yellow. The word “on” 21B is green. The words and punctuation “the street.” 21C are blue. The font color display component 22 reflects this as it has three portions, with portion 22A being yellow, portion 22B being green, and portion 22C being blue. FIG. 6A depicts the font attribute dialogue 20 and selected text, as seen in preview component 21, before any action has been taken to modify the text in accordance with the embodiment of the invention illustrated in FIGS. 6B, and 6C.

FIG. 6B shows the font attribute dialogue 20 of FIG. 6A with the addition of an action being available to a user. In FIG. 6B, a user can select and apply a single color of the font color display component 22 to the entirety of the selected text by choosing a color using the prompt 28. In this example, a user is selecting the color green, previously identified in FIG. 6A as portion 22B of the font color display component 22.

FIG. 6C displays the resulting font attribute dialogue 20 and text 29, as seen in preview component 21, after a user has selected a color in the font color display component 22 and applied it to the entirety of the selected text. As noted above, a user has selected the color green to apply to the entirety of the selected text. As preview component 21 shows, the resulting text 29 has been changed from its previous multicolored state to being entirely colored green. The font color display component 22 reflects this change as, instead of its previous multicolored state so illustrated in FIGS. 6A and 6B, it is now entirely colored green. Thus, in accordance with an aspect of this invention, a user has selected a font color found in a multicolored portion of text and applied that color to the entirety of the selected text.

Note that although the action a user takes to select and apply a font color is depicted above in FIG. 6B as a prompt 29 associated with the font color display component 22, this is a non-limiting example.

While the figures illustrate embodiments of the invention as relating to font attribute dialogues, additional embodiments can include, but are not limited to, font color display components located in toolbars, toolbar buttons, pull-down menus, and pull-down menus off of toolbars or toolbar buttons.

Although the above figures and discussion depict the invention using a sample selected text having three colors, the number of colors need not be three. As a minimum, the invention can function with two colors. In the alternative, as a non-limiting example, the invention can function with as many colors as are available in the electronic device or system.

As noted above, this invention allows for new actions associated with font colors and multicolored portions of text. One embodiment comprises allowing a user to change an individual font color of the plurality of font colors of the selected portion of text, as discussed above with regards to FIG. 5. Another embodiment features a different new action by allowing a user to select and apply one color of the plurality of colors of the selected portion of text to the entire selected text, as illustrated in FIGS. 6A, 6B, and 6C, and as discussed above with regards to those figures.

The embodiments of this invention may be implemented by a method, a computer program comprising program instructions embodied on a tangible computer-readable medium, execution of said computer program resulting in operations comprising the invention, an apparatus comprising means for performing the invention, or an apparatus comprising a display, a user interface, a memory, and at least one data processor coupled to the memory, wherein the at least one data processor is configured to execute a program of machine-readable instructions capable of interacting with the user interface and display to perform the operations of the invention.

The method, computer program, apparatus comprising means for performing the invention, and apparatus comprising a display, a user interface, a memory, and at least one data processor coupled to the memory, wherein the at least one data processor is configured to execute a program of machine-readable instructions capable of interacting with the user interface and display to perform the operations of the invention may themselves be implemented to function with or on various electronic devices including, but not limited to, cellular phones, smart phones, personal digital assistants (PDAs), computers, gaming devices, music storage and playback devices, Internet appliances, as well as units or terminals that incorporate combinations of such functions.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should also be noted that the exemplary embodiments of the inventions may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the present invention, and not in limitation thereof.

What is claimed is:

1. A method for displaying font colors of a selected portion of text having a plurality of font colors, comprising:
gathering data about the selected portion of text including at least font color attributes used in the selected portion of text;
determining information, using the gathered data, including at least a plurality of font colors used in the selected portion of text; and
displaying, using the determined information, the plurality of font colors of the selected portion of text in at least one font color display component, wherein at least two of the colors of the plurality of font colors comprise a display portion of at least one font color display component.

2. The method of claim 1, wherein at least one of the font color display components comprises one of a toolbar button, a pull-down menu, a pull-down menu off of a toolbar button, and a portion of a separate font attribute dialogue.

3. The method of claim 1, wherein the gathered data additionally includes relative usage of the font colors in the selected portion of text as compared to the entire portion of selected text and at least one font color display component displays the font colors used as a function of their relative usage as compared to the entire portion of selected text.

4. The method of claim 3, wherein relative usage of font colors is determined by counting characters from the selected portion of text.

5. The method of claim 1, wherein the gathered data additionally comprises order of the font colors used in the selected portion of text, and at least one font color display component displays the font colors used as a function of their order within the selected portion of text.

6. The method of claim 1, further comprising selectively applying at least one of the font colors of the plurality of font colors to the selected portion of text.

7. The method of claim 1, further comprising selectively changing at least one of the font colors of the plurality of font colors.

8. The method of claim 1, further comprising determining, using trigger functionality, whether to update at least one font color display component.

9. A computer program for displaying font colors of a selected portion of text having a plurality of font colors, comprising program instructions embodied on a tangible computer-readable medium, execution of said computer program resulting in operations comprising:
in response to a user selecting a portion of displayed text;
gathering data about the selected portion of text including at least font color attributes used in the selected portion of text;
determining information, using the gathered data, including at least a plurality of font colors used in the selected portion of text; and
displaying, using the determined information, the plurality of font colors of the selected portion of text in at least one font color display component, wherein at least two of the colors of the plurality of font colors comprise a display portion of at least one font color display component.

10. The computer program of claim 9, wherein at least one of the font color display components comprises one of a toolbar button, a pull-down menu, a pull-down menu off of a toolbar button, and a portion of a separate font attribute dialogue.

11. The computer program of claim 9, wherein the gathered data additionally comprises relative usage of the font colors in the selected portion of text as compared to the entire portion of selected text, and at least one font color display component displays the font colors used as a function of their relative usage as compared to the entire portion of selected text.

12. The computer program of claim 11, wherein relative usage of font colors is determined by counting characters from the selected portion of text.

13. The computer program of claim 9, wherein the gathered data additionally includes order of the font colors used in the selected portion of text and at least one font color display component displays the font colors used as a function of their order within the selected portion of text.

14. The computer program of claim 9, wherein the program is operable to selectively apply one of the font colors of the plurality of font colors to the selected portion of text.

15. The computer program of claim 9, wherein the program is operable to selectively change at least one of the font colors of the plurality of font colors.

16. The computer program of claim 9, wherein execution of said computer program results in operations further comprising determining, using trigger functionality, whether to update at least one font color display component.

17. An apparatus for displaying font colors of a selected portion of text having a plurality of font colors, comprising:
means for gathering data about a selected portion of displayed text including at least font color attributes used in the selected portion of text;
means for determining information, using the gathered data, including at least a plurality of font colors used in the selected portion of text; and
means for displaying, using the determined information, the plurality of font colors of the selected portion of text in at least one font color display component, wherein at least two of the colors of the plurality of font colors comprise a display portion of at least one font color display component.

18. The apparatus of claim 17, wherein at least one of the font color display components comprises one of a toolbar button, a pull-down menu, a pull-down menu off of a toolbar button, and a portion of a separate font attribute dialogue.

19. The apparatus of claim 17, wherein the gathered data additionally comprises relative usage of the font colors in the selected portion of text as compared to the entire portion of selected text, and at least one font color display component displays the font colors used as a function of their relative usage as compared to the entire portion of selected text.

20. The apparatus of claim 19, wherein relative usage of font colors is determined by counting characters from the selected portion of text.

21. The apparatus of claim 17, wherein the gathered data additionally includes order of the font colors used in the selected portion of text and at least one font color display component displays the font colors used as a function of their order within the selected portion of text.

22. The apparatus of claim 17, wherein additional means are provided for selectively applying one of the font colors of the plurality of font colors to the selected portion of text.

23. The apparatus of claim 17, wherein additional means are provided for selectively changing at least one of the font colors of the plurality of font colors.

24. The apparatus of claim 17, further comprising means for determining, using trigger functionality, whether to update at least one font color display component.

25. An apparatus for displaying font colors of a selected portion of text having a plurality of font colors, comprising:
a display;
a user interface;
a memory;
at least one data processor coupled to the memory, wherein the at least one data processor is configured to execute a program of machine-readable instructions capable of interacting with the user interface and display to perform the operations of:
gathering data about a selected portion of displayed text including at least font color attributes used in the selected portion of text;
determining information, using the gathered data, including at least a plurality of font colors used in the selected portion of text; and
displaying, using the determined information, the plurality of font colors of the selected portion of text in at least one font color display component, wherein at least two of the colors of the plurality of font colors comprise a display portion of at least one font color display component.

26. The apparatus of claim 25, wherein at least one of the font color display components comprises one of a toolbar button, a pull-down menu, a pull-down menu off of a toolbar button, and a portion of a separate font attribute dialogue.

27. The apparatus of claim 25, wherein the gathered data additionally comprises relative usage of the font colors in the selected portion of text as compared to the entire portion of selected text, and at least one font color display component displays the font colors used as a function of their relative usage as compared to the entire portion of selected text.

28. The apparatus of claim 27, wherein relative usage of font colors is determined by counting characters from the selected portion of text.

29. The apparatus of claim 25, wherein the gathered data additionally includes order of the font colors used in the selected portion of text and at least one font color display component displays the font colors used as a function of their order within the selected portion of text.

30. The apparatus of claim 25, wherein the program is operable to selectively apply one of the font colors of the plurality of font colors to the selected portion of text.

31. The apparatus of claim 25, wherein the program is operable to selectively change at least one of the font colors of the plurality of font colors.

32. The apparatus of claim 25, wherein execution of the program performs operations further comprising determining, using trigger functionality, whether to update at least one font color display component.

33. The apparatus of claim 32, embodied as a portable handheld device.

34. A computer program for displaying font colors of a selected portion of text having a plurality of font colors, comprising program instructions embodied on a tangible computer-readable medium, execution of said computer program resulting in operations comprising:
in response to a user selecting a portion of displayed text;
gathering data about the selected portion of text including at least font color attributes used in the selected portion of text;
determining information, using the gathered data, including at least a plurality of font colors used in the selected portion of text; and
displaying, using the determined information, the plurality of font colors of the selected portion of text in at least two font color display components, wherein each color of the plurality of font colors comprises a separate font color display component.
